(19) United States
(12) Patent Application Publication
(10) Pub. No.: US 2020/0187580 A1
(43) Pub. Date: Jun. 18, 2020

(54) Diminution of Impact Force and Acceleration by Phase Change of a Substance on Impact

(71) Applicants: Henry Buchwald, Edina, MN (US); Thomas J. O'Dea, Shoreview, MN (US)

(72) Inventors: Henry Buchwald, Edina, MN (US); Thomas J. O'Dea, Shoreview, MN (US)

(21) Appl. No.: 16/712,533

(22) Filed: Dec. 12, 2019

Related U.S. Application Data
(60) Provisional application No. 62/778,426, filed on Dec. 12, 2018.

(51) Int. Cl. A42B 3/06; B60R 19/20; F16F 9/00

(52) U.S. Cl. CPC A42B 3/06; B60R 2019/186; F16F 9/006; B60R 19/20

(57) ABSTRACT

A method and system of absorbing the shock force of an impact including a substance which absorbs at least part of the shock force of an impact by changing phase from a first phase to a second phase, and back to the first phase on cessation of the impact force, and a container for the substance for protecting a person from an impact injury.

### CROSS-REFERENCE TO RELATED APPLICATIONS

This Application claims the benefit of and priority to U.S. Provisional Application No. U.S. 62/778,426, filed Dec. 12, 2018, the entire contents of which is hereby incorporated by reference.

### STATEMENT REGARDING FEDERALLY SPONSORED RESEARCH

Not Applicable.

### BACKGROUND OF THE INVENTION

Concussions are of major concern in certain sports (e.g. football) and other civilian (e.g., cycling), as well as military activities. Concussions are estimated to occur in six per thousand individuals and are the most common type of brain injury leading to various forms or neurocognitive impairment. Lacking specific post-concussion therapy and following the edict that prevention is preferable to treatment, protective headgear, or helmets, have been developed and are under continuing modification and improvement. What is needed is a way to provide better protection against impact injuries. Sports-related concussions, especially in football players, have come to the attention of the healthcare community, regulatory bodies, and the general public. Primary sports concern is focused on prevention, which, in turn, is focused on changing the rules of game conduct and incurred penalties of concussion-prone athletics, as well as the development of protective equipment, e.g., anti-concussion helmets. Concussion concern is not limited to sports, but has applicability in designing protective headgear for motorcycling, bicycling, and other head vulnerable activities, as well as for use by the armed services.

Concussions are the most common type of traumatic brain injury. Symptoms of concussions include a variety of physical, cognitive, and emotional symptoms, which may not be recognized if subtle. A variety of symptoms may accompany concussions including headache, feeling in “a fog,” and emotional lability. Signs of concussion include loss of consciousness, amnesia, behavioral changes (such as irritability), cognitive impairment (such as slowed reaction time), and sleep disturbances.

The national incidence of concussions is estimated at 6 per 1,000 people. Those who have had one concussion are more susceptible to another, especially if the new injury occurs before symptoms of the previous concussion have completely resolved. There is also an additive effect of several minor concussions having the equivalency of a major concussion event.

Without specific knowledge of causative mechanisms, repeated concussions have been demonstrated to be responsible for later life dementia, Parkinson's disease, amyotrophic lateral sclerosis (Lou Gehrig's disease), depression, and other mental, neurologic, degenerative processes, often leading to near or total impairment of quality of life, and premature death, often by suicide.

There is no specific therapy for acute concussion except for the empiric recommendation for rest and avoidance of repeated trauma, especially within the immediate three to four weeks following the concussion event. Diagnoses of chronic sequellae are, for the most part, subjective and lack specific diagnostic tests of assessment. Specific therapy for these mental/neurologic sequellae is essentially non-existent.

Because of the lack of specific, curative therapy, as well as the general principle that prevention is preferable to post-insult treatment, primary efforts in concussion management have focused on prevention. In these efforts, emphasis has been focused on the development of protective helmets for certain sports, e.g., football, ice hockey, baseball, boxing, lacrosse, bicycling, etc. These helmets seek to perform the function of shock absorbers and to mitigate the trauma impact on the brain, which can be displaced and shaken within the cranial cavity by a violent blow to the cranium, neck, or body. These same principles of designing concussion protective headgear are applicable to efforts outside of sports in civilian and military life.

Without limiting the scope of the invention a brief summary of some of the claimed embodiments of the invention is set forth below. Additional details of the summarized embodiments of the invention and/or additional embodiments of the invention may be found in the Detailed Description of the Invention, below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

The invention provides an inventive system in concussion prevention: namely, the absorption of the impact force responsible for a concussion by a phase change in a substance on impact. This phase change can be from gas to liquid or gas to solid powder, a phase change that absorbs energy and drastically reduces volume. The mechanical energy absorbed is transformed into heat. When impact is terminated, the process is reversed and the selected substance returns to its stable gaseous state in a predetermined temperature range at one atmosphere.

This invention can be used to prevent impact injuries in many different contexts, whether in a sports setting in a helmet or other headgear, or in a safety context, for example in a bumper or other portions of a car or bicycle or other comparable conveyance or static structure that maybe subjected to an impact force, as well as any other device to prevent impact injuries. The helmets can be for any sport, such as football or hockey or any other sport which wears head protection, while the headgear could be for any sport such as boxing or other martial arts, or any sport which wears head protection. A static structure could be a police shield, for example.

The biphasic substance is contained in a pressure pouch or container suitably fitted in a helmet or other headgear, or in a bumper. The principles for shock absorption detailed are applicable to various embodiments of phase-altering substance, the container for the substance, its fixation to headgear, a helmet, or other impact protective device and heat-absorption mechanisms, such as a bumper, as well as variations in materials, construction, and application governed by the principle of a phase change of a substance to provide shock absorption.

The invention provides a method and system of absorbing the shock force of an impact including a substance which absorbs at least part of the shock force of an impact by changing phase from a first phase to a second phase, and back to the first phase on cessation of the impact force, and a container for the substance for protecting a person from an impact injury.

The first phase can be either gas or liquid and the second phase can either by liquid or solid. The invention can be embodied in a helmet or other headgear, or in other safety devices such as a vehicle bumper.

The substance changes phase when the container holding the substance receives an impact force over a predetermined level, which converts a portion of the impact force to heat and displacing volume of the container causing it to shrink, and then after the impact has been absorbed, the substance returns to its first state, causing the enclosure to return to its original volume.

The substance in the first phase is gaseous over a predetermined temperature range, and the substance will turn into the second phase which is liquid, under the predetermined level of impact, thereby converting a portion of the impact force to heat and displacing volume of the enclosure causing it to shrink, and then after the impact has been absorbed, the material returns to its gaseous state, causing the enclosure to return to its original volume.

The predetermined temperature range is 0 to 110 F. The substance is selected from the group consisting of carbon dioxide sublimates, Freon, R-21, R-123, FC-88, R134a and all similar substances commercially available now or which become available in the future. The predetermined impact level which causes the substance to change phase can be variable, such as five gravities.

### BRIEF DESCRIPTION OF THE DRAWINGS

FIG. 1 shows a drawing of a pod containing material for absorption of impact by change of state.

FIG. 2 shows a schematic helmet on a head is shown, with a pouch between the hard shell of the helmet and the persons head.

FIG. 3 shows the helmet after an impact above the threshold amount.

FIG. 4 shows an alternative embodiment of the invention embodied in a bumper to protect passengers in a vehicle from an impact injury.

### DETAILED DESCRIPTION OF THE INVENTION

The invention uses the phase change (i.e. from gas to liquid or gas to solid powder) and the solubility properties of the material a device, such as filling the cushion pockets of athletic or other protective head gear, or a bumper on a vehicle, to improve the protection against concussion. Although the invention is described herein as embodied in a helmet or other headgear, or in a bumper connected to a vehicle, it should be understood that the invention can be used in connection with any device designed to prevent injury from an impact.

The purpose of the headgear used to prevent concussive injuries, from a physics point of view, is to spread out the effects of head impact in both space and time from the point and moment of impact, and to absorb the energy of that impact to the greatest extent possible. Prior studies indicate that the present headgear used in football may attenuate the force of impact by up to ten times; from approximately 1000 foot pounds to 100.

A number of physics principles are helpful in achieving these goals:

The impulse momentum formulation of Newton's second law of motion defines impulse (the force integrated over the time during which the force is applied) equals the change in momentum (in this case the head). Mathematically stated:

∫ₜ^{t}F×δt=Δ(m×v)

Where F is the force applied to the head, t is the time over which the force is applied, m is the mass of the head and v is the final velocity of the lead after impact, assuming the head is motionless initially.

The definition of pressure and Pascal's Law defines pressure as the force applied per unit area,

p=F/A

Where A is the Area over which the force is applied.

Pascal's law indicates that pressure is transmitted undiminished through a medium, usually gaseous or liquid.

The severity index (I), an experimental quantity derived from crash test experiments, indicates the likelihood of concussion from a head trauma. Acceleration (a) raised to the 3/2 power is integrated over time, showing the higher relative importance of acceleration in head trauma.

$$I = {\int }_{t 1}^{t 2} {a}^{\frac{3}{2}} dt$$

Conservation of angular momentum: The rotation of the head from a blow that is off center from the place where the head is attached to the body (i.e.; the neck) generates a torque (T) which is proportional to the force (F) and the distance from the center of rotation (r) multiplied by the angular acceleration equals the change in the angular momentum. The initial state of head rotation is usually zero. I is the moment of inertia of the head around the point of attachment to the body (i.e.; the neck) and \acute{ω} is the angular velocity.

T×a=(I×ω)−(I×ω)ₒ

Application of the above principles to helmet design:

The shell of the helmet is usually deigned to be smooth plastic without outcroppings. The plastic is strong enough to prevent penetration and the smoothness lessens the time during which an impact is in contact with the wearer. Thus the time factor in all the equations given above is decreased, lessening the changes in momentum.

Suspension system: Inside the shell of the helmet is attached a suspension system, usually consisting of straps attached to the shell but maintaining a distance from the head to the hard shell. This system spreads the force of the impact over a larger area and again increases the time of the impact to the head.

The inside of the shell usually has packets of energy absorbing material to insure that the head does not “bottom out” on the shell during high impact and to absorb the energy of the high g impacts. It is this layer of protection that this patent addresses.

Since the concussion damage to the player is based on the acceleration to the head (brain) as shown in the literature and the force for a given impact is equal to F=ma

The greater the effective mass of the head, i.e.; the strength of the neck which attaches the head to the body, the less the acceleration for a given force. This is improved by proper conditioning and improved tackling and blocking technique.

For a given change in momentum, the more the force to the head is reduced by padding or in this case change of physical properties of the padding material, the greater protection from concussion.

The more the effect to the head is spread out in time and space by head protection, the less the force and thus head acceleration is decreased.

Scientific basis of the invention: When a material changes state, it absorbs/releases energy, usually in the form of heat, and drastically changes volume. In this application, a change of state from a gas to a liquid or solid will absorb mechanical energy and transform it into heat.

Logic:

If a contained gas at a specific pressure and temperature occupies a given volume, that is; at a given enthalpy, then a change of pressure from a blow to the head can be used to change the state of the gas to a liquid or a solid, thus absorbing energy and reducing the volume of the enclosed substance. Thus the energy from the blow is absorbed and less concussive force reaches the head.

When the blow is over, the pressure is reduced and the substance goes back to the gaseous state.

Thus incorporation of such a substances into the protective, pouches of the helmet would be helpful in protection against concussion.

In order to dissipate the heat energy (latent heat of fusion or vaporization) generated by the change of state generated by a high g impact, an absorbent sleeve over the protective pouch can be moistened by the perspiration of the player and dissipate the latent heat by evaporation on impact.

Possible substances: We look for substances that can change state at reasonable temperatures (i.e. 60-100 degrees F. and pressures (i.e. those caused by a blow of 5 gravities or more).

Carbon dioxide sublimates (goes from gas to solid and vice versa) at one atmosphere and −175 degrees C. At realistic pressures and temperatures, change of state is not a possible mechanism. However the solubility of carbon dioxide gas in water may also be used to cushion impact as the gas dissolves in water more at higher pressures, thus lessening gas volume at higher pressures.

Freon (trichlorofluoromethane or R11) evaporates at 75 degrees F. and one atmosphere. However it is no longer manufactured in the US due to its effect on the ozone layer.

R-21: (dichlorodifluoromethane) evaporates at approximately 48 degrees F. and one atmosphere.

R-123 (dichlorotrifluoroethane) evaporates at approximately 82 degrees F. and one atmosphere.

FC-88 (mixture of perfluoropentane isomers) evaporates at approximately 80 degrees F. at one atmosphere. This substance is chemically inert, nonflammable, and nontoxic.

R134a (tetrafluoroethane) evaporates at approximately −14 degrees F. and one atmosphere. Because of its availability, lack or toxicity, use in freezing of skin lesions, low flammability, and minimal effect on global warming and ozone depletion, this was a first experimental choice.

Others: a) to f) listings are not exhaustive and other substances fulfilling the change of state criteria may be used.

Use of enthalpy diagrams to determine change of state: Imagine R134a at 15 psia (1 atmosphere) and 80 degrees F. It is a gas. At 100 psia (6-7 atmosphere) and 80 degrees F. it becomes a liquid, changing volume by at least a factor of 20 and releasing heat, which changes R134a back to gas.

Possible structure: Inside of each pressure pouch (which the aforementioned helmets all have in various geometries) the appropriate gas is placed (e.g. R134a) at the appropriate pressure to allow condensation or sublimation at the upper pressure of maximum impact. The “sponge” which is placed there to prevent “bottoming out” is treated to absorb or adsorb the liquid when the gas condenses. If a higher pressure is required than that safely attainable on filling, a porous barrier can be placed between gas and sponge After impact, the pressure returns to one atmosphere and the “pod” is ready for the next impact.

Advantages

Changes restricted to design and construction of a single helmet component

Easily tested and replaced

If the helmet is fitted by adding or subtracting gas, the pressure can be easily measured.

Testing the concept in vivo:

Test of concept (not particular or exclusive to football helmet or other protective device):

Package a sample of the gas at a particular volume and subject it to impact and verify that the volume change is instantaneous and significant.

Static test with weight:

A head form is instrumented with a force or pressure transducer and affixed to a solid surface. A force or pressure transducer is affixed to the outside of the helmet which is placed on the head form.

A weight is dropped from various heights to simulate various momenta found in contact sports or other impact situations. The velocity of the weight on impact can be calculated from the height (h) from which it is dropped. v=√2gh and thus the helmet impact (impulse) is given by

mv=m√2gh and the impulse by

∫₀^{t}F×δt=Δ(m×v)=m√2gh

Thus knowing the original height and mass of the weight, which simulates an impact, the impulse on the helmet is known.

The weight is lifted to the appropriate height to simulate the momentum of head impact in the appropriate sport or other situation (e.g. motorcycle driving, bicycling, military explosions, etc).

Simultaneously, the weight is released and the two channel scope measures and records the output of the force (pressure) transducers on the outside of the helmet and the head form (phantom).

The experiment is repeated for the helmet with the patented insert in place.

The following parameters are compared for a variety of impulses (the values varying with the activity):

Area under the force vs time curve on the phantom and on the exterior of the helmet

The ratios between the values on the helmet and the phantom of: impulse, peak force, and time

The experiment is repeated for the helmet completely fitted with the inset and all the ratios are compared

Acceleration test:

The above experiment does not take into effect the state of readiness of the subject by changes in the neck as a connection between head and body and does not directly measure acceleration.

A comparable head form and helmet as used in a static test are employed.

The helmet is fitted with the aforementioned devices for the static test and also with accelerometers. The head form is also fitted with accelerometers. Comparison of accelerometers gives a measure of the static effectiveness of the inset. The advantage of this is that it addresses acceleration, the common unit addressed in the literature and the parameter seemingly most important in concussion studies. This however requires a more elaborate phantom since the head-body connection largely determines head acceleration and thus injury.

The head form could be allowed fixed degrees of motion to simulate head motion and rotation and the aforementioned tests repeated. This test requires the following alterations to the static test described above:

The head phantom is attached to the solid block by a torsion spring which has both linear replaced and rotational degrees of motion.

The sensors in the helmet are replaced by accelerometers. At least three linear and one rotational accelerometers are placed on the head form or helmet inner surface.

Thus three or four channels must be monitored,

The impact system is modified to allow off center impact and side impact, perhaps by a swinging weight system.

Advantages:

Acceleration is a common measurement in impact studies.

The effect of the inventions can be measured on the common variable. Animal tests are practically impossible but static tests can be performed on cadavers. Human tests are complicated and require multiple approvals.

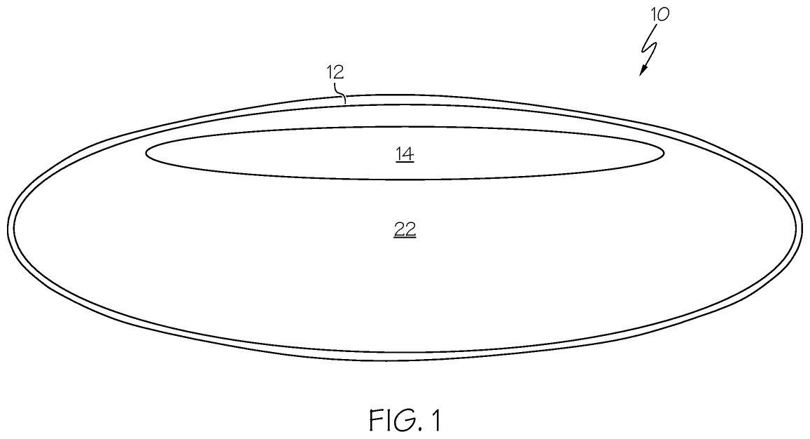

Referring now to FIG. 1, a drawing of a pod, shown generally at 10 containing material for absorption of impact by change of state is shown. In FIG. 1 the membrane holding the substance is shown at 12, which holds the substance which changes state upon a threshold impact, which is shown at 14.

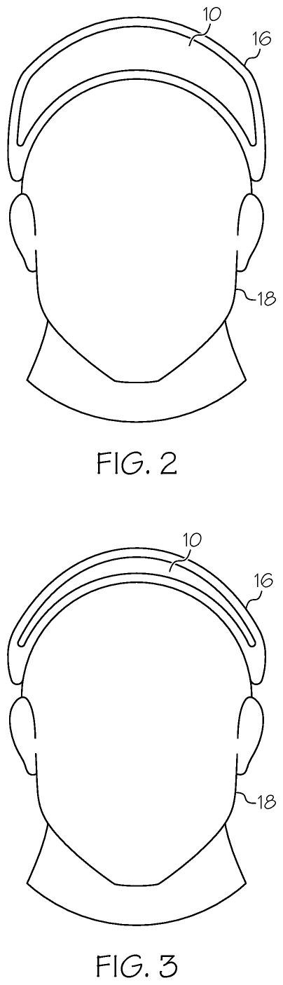

Referring now to FIG. 2, a schematic helmet 16 on a head 18 is shown, with a pouch 10 between the hard shell of the helmet and the persons head.

Referring now to FIG. 3, the helmet 16 is shown after an impact above the threshold amount, which has caused the material in the enclosure 10 to change state from gaseous to liquid (or solid) and therefore reduce the volume of the enclosure, thereby changing some of the impact energy to heat.

Air holes or channels can be provided so air will fill in the displaced volume caused by collapse of the enclosure, from the increased pressure in the enclosure, and the air will be dispelled in reverse when the enclosure re-inflates as the material changes back to its gaseous state when the pressure drops back to its normal level.

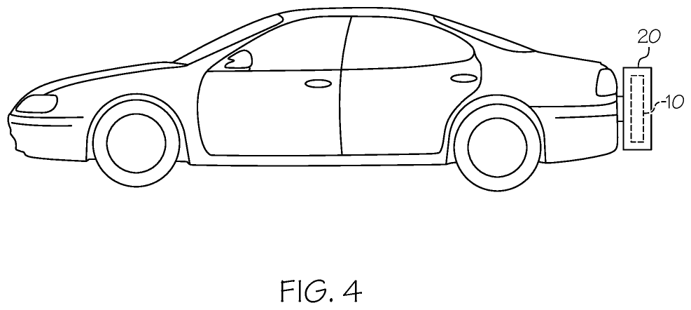

Referring now to FIG. 4, an alternative embodiment of the invention is shown in which the substance 10 is embodied in a bumper 20 to protect passengers in a vehicle from an impact injury.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method of absorbing the shock force of an impact comprising the steps of:
providing a substance which absorbs at least part of the shock force of an impact by changing phase from a first phase to a second phase, and back to the first phase on cessation of the impact force,
providing a container for the substance for protecting a person from an impact injury.

2. The method of claim 1 wherein the first phase is gas and the second phase is liquid.

3. The method of claim 1 wherein the first phase is gas the second phase is solid.

4. The method of claim 1 wherein the first phase is liquid and the second phase is solid.

5. The method of claim 1 wherein the container is a helmet or headgear constructed and arranged to hold the substance such that upon an impact over a predetermined level the substance in the container will turn from its first phase to its second phase, thereby converting a portion of the impact energy to heat and displacing volume of the container causing it to shrink, and then after the impact has been absorbed, the material returns to its first state, causing the enclosure to return to its original volume.

6. The method of claim 1 wherein the container is a vehicle bumper or other portions of a car or bicycle or other comparable conveyance or static structure that maybe subjected to an impact force, constructed and arranged to hold the substance such that upon an impact over a predetermined level the substance in the container will turn from its first phase to its second phase, thereby converting a portion of the impact energy to heat and displacing volume of the container causing it to shrink, and then after the impact has been absorbed, the material returns to its first state, causing the enclosure to return to its original volume.

7. A system of absorbing the shock force of an impact comprising:
a substance which absorbs at least part of the shock force of an impact by changing phase from a first phase to a second phase, and back to the first phase on cessation of the impact force,
a container for the substance for protecting a person from an impact injury.

8. The system of claim 7 wherein the first phase is gas and the second phase is liquid.

9. The system of claim 7 wherein the first phase is gas the second phase is solid.

10. The system of claim 7 wherein the first phase is liquid and the second phase is solid.

11. The system of claim 7 wherein the container is a helmet or headgear constructed and arranged to hold the substance such that upon an impact over a predetermined level the substance in the container will turn from its first phase to its second phase, thereby converting a portion of the impact energy to heat and displacing volume of the container causing it to shrink, and then after the impact has been absorbed, the material returns to its first state, causing the enclosure to return to its original volume.

12. The system of claim 11 wherein the substance in the helmet is positioned inside the helmet between an outside surface of the helmet and the inside surface near the head of a person wearing the helmet;
the substance in the helmet is in the first phase which is gaseous over a predetermined temperature range, and the substance will turn into the second phase which is liquid, under the predetermined level of impact, thereby converting a portion of the impact energy to heat and displacing volume of the enclosure causing it to shrink, and then after the impact has been absorbed, the material returns to its gaseous state, causing the enclosure to return to its original volume.

13. The head protection of claim 12 wherein the predetermined temperature range is 0 to 110 F.

14. The head protection of claim 12 wherein the material in the pouch is selected from the group consisting of carbon dioxide sublimates, Freon, R-21, R-123, FC-88, R134a and all similar substances commercially available now or which become available in the future.

15. The head protection of claim 12 wherein the predetermined threshold impact pressure is variable.

16. The head protection of claim 15 wherein the predetermined threshold impact pressure is five gravities.

17. The system of claim 7 wherein the container is a vehicle bumper vehicle bumper or other portions of a car or bicycle or other comparable conveyance or static structure that maybe subjected to an impact force, constructed and arranged to hold the substance such that upon an impact over a predetermined level the substance in the container will turn from its first phase to its second phase, thereby converting a portion of the impact energy to heat and displacing volume of the container causing it to shrink, and then after the impact has been absorbed, the material returns to its first state, causing the enclosure to return to its original volume.
